(19) United States
(12) Patent Application Publication
(10) Pub. No.: US 2025/0078547 A1
(43) Pub. Date: Mar. 6, 2025

(54) WARPING-FREE MOTION GUIDED FEATURE REFERENCING FOR CONSISTENT VIDEO SEGMENTATION

(71) Applicant: QUALCOMM Incorporated, San Diego, CA (US)

(72) Inventors: Hyojin Park, San Diego, CA (US); Jisoo Jeong, San Diego, CA (US); Hong Cai, San Diego, CA (US); Fatih Murat Porikli, San Diego, CA (US)

(21) Appl. No.: 18/461,366

(22) Filed: Sep. 5, 2023

(51) Int. Cl. G06V 20/70; G05D 1/02; G06V 10/62; G06V 10/77; G06V 10/774; G06V 10/776; G06V 10/82; G06V 20/40

(52) U.S. Cl. CPC G06V 20/70; G06V 10/62; G06V 10/7715; G06V 10/774; G06V 10/776; G06V 10/82; G06V 20/46; G06V 20/49

(57) ABSTRACT

An example system include one or more memories and one or more processors coupled to the one or more memories. The one or more processors are configured to perform a first segmentation operation on a previous frame of image data to generate first segmentation data. The one or more processors are configured to perform a deformable convolution operation based on the first segmentation data to generate a deformable convolution output. The one or more processors are configured to perform a second segmentation operation on a current frame of image data to generate second segmentation data. The one or more processors are configured to combine the deformable convolution output with the second segmentation data to generate third segmentation data and control operation of a device based on the third segmentation data.

### TECHNICAL FIELD

This disclosure relates to image segmentation.

### BACKGROUND

Accurate image segmentation may be important for various use cases. For example, accurate image segmentation (e.g., the identification and classification of a pixel in an image as belonging to a particular class of objects) may be important for navigation, such as obstacle avoidance. Navigation may be associated with autonomous driving, robotics, extended reality (XR) scene composition, and the like. Accurate image segmentation also be important for 3D construction of an environment, a spatial scene understanding (e.g., for image editing), and other use cases.

### SUMMARY

The present disclosure generally relates to the use of utilize a pseudo-optical flow operation to add temporal information to improve temporal consistency for an image segmentation model. By using a pseudo-optical flow operation, rather than a traditional or more recently developed optical flow operation, such as a Recurrent All-Pairs Field Transforms (RAFT) operation, the techniques of this disclosure may address temporal inconsistencies in the image segmentation model and may be operable on device, as the pseudo-optical flow operation, described in this disclosure, may be less computationally demanding than an optical flow operation. The techniques of this disclosure may be useful for several type of devices, such as self-driving vehicles, XR devices, robots, and/or the like.

In one example, this disclosure describes a system comprising: one or more memories configured to store image data captured by at least one camera; and one or more processors communicatively coupled to the one or more memories, the one or more processors being configured to: perform a first segmentation operation on a previous frame of the image data to generate first segmentation data; perform a deformable convolution operation based on the first segmentation data, to generate a deformable convolution output; perform a second segmentation operation on a current frame of the image data to generate second segmentation data; combine the deformable convolution output with the second segmentation data to generate third segmentation data; and control operation of a device based on the third segmentation data.

In another example, this disclosure describes a method comprising: performing a first segmentation operation on a previous frame of image data to generate first segmentation data; performing a deformable convolution operation based on the first segmentation data, to generate a deformable convolution output; performing a second segmentation operation on a current frame of the image data to generate second segmentation data; combining the deformable convolution output with the second segmentation data to generate third segmentation data; and controlling operation of a device based on the third segmentation data.

In another example, this disclosure describes a non-transitory, computer-readable storage medium, comprising instructions, which, when executed, cause one or more processors to: perform a first segmentation operation on a previous frame of image data to generate first segmentation data; perform a deformable convolution operation based on the first segmentation data, to generate a deformable convolution output; perform a second segmentation operation on a current frame of the image data to generate second segmentation data; combine the deformable convolution output with the second segmentation data to generate third segmentation data; and control operation of a device based on the third segmentation data.

In another example, this disclosure describes a system comprising: means for performing a first segmentation operation on a previous frame of image data to generate first segmentation data; means for performing a deformable convolution operation based on the first segmentation data, to generate a deformable convolution output; means for performing a second segmentation operation on a current frame of the image data to generate second segmentation data; means for combining the deformable convolution output with the second segmentation data to generate third segmentation data; and means for controlling operation of a device based on the third segmentation data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example vehicle according to one to more aspects of this disclosure.

FIG. 2 is a conceptual diagram illustrating an example architecture of a system for providing a depth prediction based on image data from a plurality of cameras according to one or more aspects of this disclosure.

FIG. 3 is a conceptual diagram illustrating an example of a decoder side architecture associated with a single camera of a plurality of cameras according to one or more aspects of this disclosure.

FIG. 4 is a conceptual diagram illustrating an example neural network according to one or more aspects of this disclosure.

FIG. 5 is a flow diagram illustrating depth prediction techniques according to one or more aspects of this disclosure.

### DETAILED DESCRIPTION

A pretrained semantic segmentation model may generate “flickering” artifacts where a given pixel of a particular object may be characterized as being in one class of objects in one image frame and then the same relative pixel of the same object may be characterized as being of a different class of objects in a next image frame, even if the object is stationary. For example, a pixel belonging to a street may be classified as a street pixel in one image frame and then be classified as a sidewalk pixel in a next image frame. Such correct and incorrect classifications may “flicker” back and forth over several image frames in an output of a segmentation orientation model, resulting in temporal inconsistency. Temporal inconsistency may degrade service quality and increase safety or other risks.

Presently, systems may use optical flow to increase temporal consistency. However optical flow typically requires a large number of computations and may cause a large bottleneck in data processing for real-time service. As such, it may be desirable to address or improve the temporal inconsistency (e.g., “flickering” artifacts) in a semantic segmentation model in a less computational intense manner, such that the model may be run in real-time and on device.

According to the techniques of this disclosure, given a pretrained image segmentation model, such as a semantic segmentation model, a device may utilize a pseudo-optical flow operation to add temporal information to improve temporal consistency. The techniques of this disclosure may be useful for several type of devices, such as self-driving vehicles, XR (eXtended reality) devices, robots, and/or the like.

Most of the urban segmentation models used for self-driving vehicles and/or advanced driver assistance (ADAS) systems are trained on clean, real datasets or simulated, game datasets. The techniques of this disclosure may be useful for online adaptation to real world scenes, where accurate segmentation masks, along with depth information, will allow the vehicle to take appropriate control actions, e.g., velocity control, steering, braking, etc.

For XR uses cases, indoor segmentation may be used for human occlusion rendering and/or semantic reconstruction. The indoor environment on which the segmentation models are trained may have different characteristics than the indoor environment in which the XR device is actually utilized. There might be changes in layout, brightness etc. In such situations, online adaptation is important to counter the domain shift of the pre-training dataset and test dataset.

Similarly, for robotics use cases, the segmentation model may be trained on an environment that differs from the environment in which the deployed robot may actually operate. Accurate semantic segmentation may enable a variety of capabilities in robotics, such as navigation, localization, and interaction with physical objects in the environment. The techniques of this disclosure may be used to address domain shift characteristics between a source dataset and a target dataset, such as changes in object characteristics, environment changes like illumination etc.

According to the techniques of this disclosure, rather than using an optical flow operation to improve temporal consistency, a device may use a pseudo-optical flow operation, on device, to improve temporal consistency, such as to reduce or eliminate “flickering” artifacts in the output of the image segmentation model. A pseudo-optical flow operation may take the form of, or include, a deformable convolution operation.

The techniques of this disclosure were tested against other implementations, such as an image based model, a video based model, and a video based model with raft warping (e.g., a recently developed form of optical flow). An image based model may be a model that uses information from a current frame of video data or a picture, but does not use information from other frames or pictures. A video based model may be a model that uses information from the current frame or picture and information from one or more previous frames (e.g., temporal information). Table 1 show results of the testing. As can be seen, the video based model with pseudo-optical flow of this disclosure outperformed the other implementations. Mean Intersection over Union (mIoU), is an average of the IoU values calculated for each class in a multi-class segmentation problem which may be used to determine performance of an implementation across different classes of objects.

TABLE 1

| Experiment | mloU |
|---|---|
| Image based model | 79.01 |
| Video based model | 79.45 |
| Video based model + Raft warping | 79.73 |
| Video based model + Pseudo optical flow | 79.98 |

The techniques of this disclosure may improve semantic segmentation quality for novel environments through online adaptation. This can improve accuracy for those classes which change characteristics across source and target datasets.

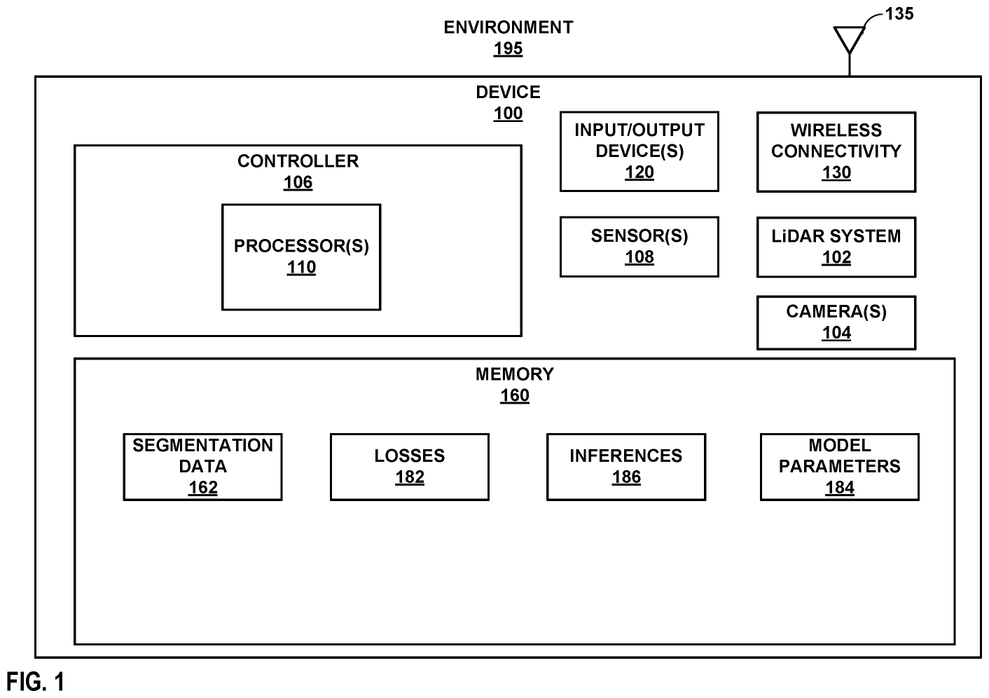

FIG. 1 is a block diagram illustrating an example device according to one to more aspects of this disclosure. Device 100 may include an autonomous driving vehicle, an assisted driving vehicle (e.g., a vehicle having an ADAS), a robot, an XR headset, a mobile device, or the like. It should be understood that based on the actual type of device, the elements discussed in FIG. 1 may vary. For example, a vehicle or a robot may include LiDAR system 102, an XR headset or a mobile device, like a smartphone, may not.

The description of FIG. 1 that follows is generally directed to the examples where the device is a vehicle or a robot. In the example where device 100 represents a self-driving vehicle, device 100 may be referred to as an ego vehicle.

Device 100 may include LiDAR system 102, one or more camera(s) 104, controller 106, one or more sensor(s) 108, input/output device(s) 120, wireless connectivity component 130, and memory 160. LiDAR system 102 may include one or more light emitters and one or more light sensors. LiDAR system 102 may be deployed in or about device 100. For example, LiDAR system 102 may be mounted on a roof of device 100, in bumpers of device 100, and/or in other locations of device 100. LiDAR system 102 may be configured to emit light pulses and sense the light pulses reflected off of objects in the environment of device 100. LiDAR system 102 (and/or processor(s) 110) may determine a distance to such objects based on the time between the emission of a light pulse and the sensing of the reflection of the light pulse. LiDAR system 102 may emit such pulses in a 360 degree field around device 100 so as to detect objects within the 360 degree field, such as objects in front of, behind, or beside device 100. While described herein as including LiDAR system 102, it should be understood that another distance or depth sensing system may be used in place of LiDAR system 102.

Depth estimation may be relatively important to a variety of applications, such as autonomous driving, assistive robotics, extended reality scene composition, image editing, and/or the like. For example, in an autonomous driving scenario, depth estimation may provide an estimated distance from one vehicle (e.g., first vehicle) to another (e.g., second vehicle), which may be important to operational systems of the first vehicle, for instance, acceleration, braking, steering, etc. Depth estimation may be implemented through leveraging any of a number of different principles, such as principles associated with camera(s) 104, sensor(s) 108, and/or LiDAR system 102.

Camera(s) 104 may include one or more camera sensors (also referred to a cameras) located in positions in or on the vehicle, such as in or on mirrors, bumpers, and/or other locations device 100. Camera(s) 104 may be configured to capture video or image data in an environment 195 around device 100. Image data may include still images and/or one or more video frames or pictures. Controller 106 may use information from camera(s) 104 for determining depth information of objects that may be in a field of view of one or more of camera(s) 104.

Controller 106 may be an autonomous or assisted driving controller (e.g., an ADAS) configured to control operation of device 100. For example, controller 106 may control acceleration, braking, and/or navigation of device 100 through the environment surrounding device 100. Controller 106 may include one or more processors, e.g., processor(s) 110. Processor(s) may include one or more central processing units (CPUs), such as single-core or multi-core CPUs, graphics processing units (GPUs), digital signal processor (DSPs), neural processing unit (NPUs), multimedia processing units, and/or the like. Instructions executed by processor(s) 110 may be loaded, for example, from memory 160 and may cause processor(s) 110 to perform the operations attributed to processor(s) in this disclosure. In some examples, one or more of processor(s) 110 may be based on an ARM or RISC-V instruction set.

An NPU is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processor(s) 110 may be configured to accelerate the performance of common machine learning tasks, such as image classification, machine translation, object detection, and various other tasks. In some examples, a plurality of processor(s) 110 may be instantiated on a single chip, such as a system on a chip (SoC), while in other examples one or more of processor(s) 110 may be part of a dedicated machine learning accelerator device.

In some examples, one or more of processor(s) 110 may be optimized for training or inference, or in some cases configured to balance performance between both. For processor(s) 110 that are capable of performing both training and inference, the two tasks may still generally be performed independently.

While depicted as being part of device 100, in some examples, such as where processor(s) 110 are used for training, processor(s) 110 may be off-device (e.g., outside of device 100). For example, processor(s) 110 may be located in a cloud computing environment. In some examples, processor(s) 110 may be partially on-device (e.g., part of device 100) and partially off-device.

In some examples, processor(s) 110 designed to accelerate training are generally configured to accelerate the optimization of new models, which is a highly compute-intensive operation that involves inputting an existing dataset (often labeled or tagged), iterating over the dataset, and then adjusting model parameters 184, such as weights and biases, in order to improve model performance. Generally, optimizing based on a wrong prediction involves propagating back through the layers of the model and determining gradients to reduce the prediction error. In some examples, some or all of the adjustment of model parameters 184 (e.g., training) may be performed outside of device 100, such is in a cloud computing environment.

In some examples, processor(s) 110 designed to accelerate inference are generally configured to operate on complete models. Such processor(s) 110 may thus be configured to input a new piece of data and rapidly process the data through an already trained model to generate a model output (e.g., an inference).

In some examples, processor(s) 110 may operate on predictive models such as artificial neural networks (ANNs) or random forests (RFs). An ANN may include a hardware and/or a software component that includes a number of connected nodes (e.g., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge may be associated with one or more node weights that determine how the signal is processed and transmitted. During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A convolutional neural network (CNN) is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

The term “loss function” refers to a function that impacts how a machine learning model is trained in a supervised learning model. Specifically, during each training iteration, the output of the model may be compared to a known ground truth. The loss function provides a value for how close the predicted data is to the actual data (e.g., the ground truth). After computing the loss function, the parameters of the model are updated accordingly and a new set of predictions are made during the next iteration.

In some aspects, wireless connectivity 130 component may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity 130 processing component is further connected to one or more antennas 135.

Processor(s) 110 may also include one or more sensor processing units associated with LiDAR system 102, camera(s) 104, and/or sensor(s) 108. For example, processor(s) 110 may include one or more image signal processors associated with camera(s) 104 and/or sensor(s) 108, and/or a navigation processor associated with sensor(s) 108, which may include satellite-based positioning system components (e.g., GPS or GLONASS) as well as inertial positioning system components.

Device 100 may also include one or more input and/or output devices 120, such as screens, touch-sensitive surfaces (including touch-sensitive displays), physical buttons, speakers, microphones, and the like.

Device 100 also includes memory 160, which is representative of one or more static and/or dynamic memories, such as a dynamic random access memory, a flash-based static memory, and the like. In this example, memory 160 includes computer-executable components, which may be executed by one or more of the aforementioned components of device 100.

Examples of memory 160 include random access memory (RAM), read-only memory (ROM), or a hard disk. Examples of memory 160 include solid state memory and a hard disk drive. In some examples, memory 160 is used to store computer-readable, computer-executable software including instructions that, when executed, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 160 store information in the form of a logical state.

This disclosure describes techniques for determining motion information by using a deformable convolution operation. Previous works may calculate a 4D correlation volume to obtain optical flow. The techniques of this disclosure leverage a feature referencing implemented deformable convolution operation, which may utilize previous features and estimate motion information to guide a current prediction.

Optical flow is a technique that may be used to describe motion, such as motion between two video frames, such as temporal adjacent video frames. For example, optical flow may determine a respective velocity for respective pixels within a frame and determine an estimate of where the pixels may be in the next frame. As such, optical flow may be a representation of motion of various portions of a frame due to motion, such as motion of device 100, environment 195, and/or objects in environment 195.

Optical flow may be used to determine or estimate three-dimensions within environment 195 and/or 3D motion of device 100 and/or other objects within environment 195. Optical flow may also be used to determine structure of objects within environment 195. Recurrent All-Pairs Field Transforms (RAFT), is a relatively recent technique for optical flow.

Generally, device 100 and/or components thereof may be configured to perform the techniques described herein. Device 100 of FIG. 1 is just one example, and in other examples, alternative device 100 with more, fewer, and/or different components may be used.

In some aspects, camera(s) 104 and/or sensor(s) 108 may include optical instruments (e.g., an image sensor, camera, etc.) for recording or capturing images, which may be stored locally, transmitted to another location, etc. For example, an image sensor may capture visual information using one or more photosensitive elements that may be tuned for sensitivity to a visible spectrum of electromagnetic radiation. The resolution of such visual information may be measured in pixels, where each pixel may relate an independent piece of captured information. In some cases, each pixel may thus correspond to one component of, for example, a two-dimensional (2D) Fourier transform of an image. Computation methods may use pixel information to reconstruct images captured by the device. In a camera, an image sensors may convert light incident on a camera lens into an analog or digital signal. An electronic device may then display an image on a display panel based on the digital signal. Image sensors are commonly mounted on electronics such as smartphones, tablet personal computers (PCs), laptop PCs, and wearable devices.

In some aspects, sensor(s) 108 may include direct depth sensing sensors, which may function to determine a depth of or distance to objects within the environment surrounding device 100. Data from such dept sensing sensors may be used to supplement the depth map generation techniques discussed herein.

Input/output device(s) 120 (e.g., which may include an I/O controller) may manage input and output signals for device 100. In some cases, input/output device(s)120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processor(s) 110). In some cases, a user may interact with a device via input/output device(s) 120 or via hardware components controlled by input/output device(s) 120.

In particular, in this example, memory 160 includes model parameters 184 (e.g., weights, biases, and/or other machine learning model parameters 184) for any of the machine learning models discussed herein. Memory 160 may also include segmentation data 162, which may include segmentation data corrected for flickering error, losses 182, each of which may be used to train one or more machine learning models described herein, inferences 186, which may include inferences made by any of the machine learning models discussed herein. One or more of the depicted components, as well as others not depicted, may be configured to perform various aspects of the techniques described herein.

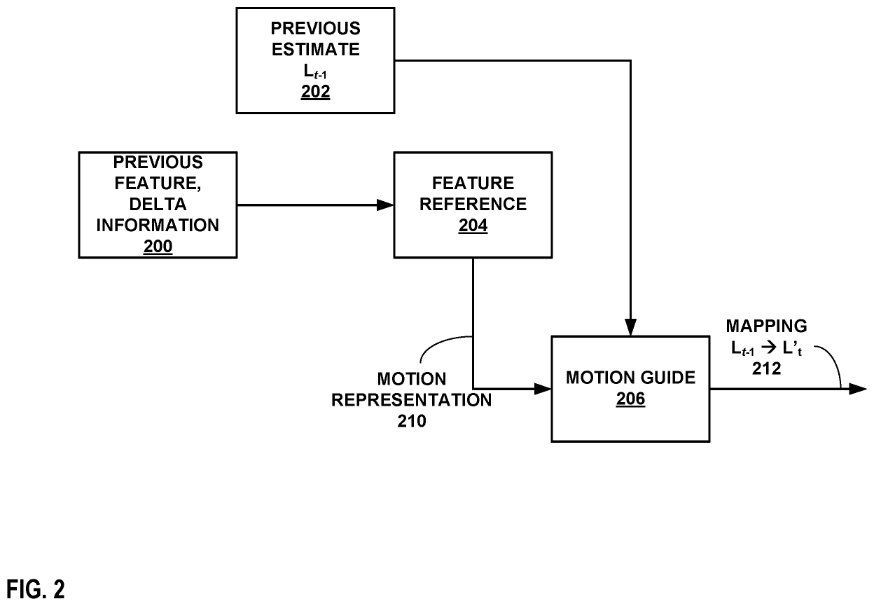

FIG. 2 is a conceptual diagram illustrating an example high level architecture for a device for video segmentation according to one or more aspects of this disclosure. The high level architecture of FIG. 2 may be implemented by device 100 of FIG. 1. For example, processor(s) 110 may compare a previous determined feature and/or delta information 200 to a feature reference 204 and determine a motion representation 210. Processor(s) 110 may use motion representation 210 and a previous estimate of Lₜ₋₁ 202 as a motion guide 206 to generate a mapping of Lₜ₋₁ to a predicted L′ₜ. 212.

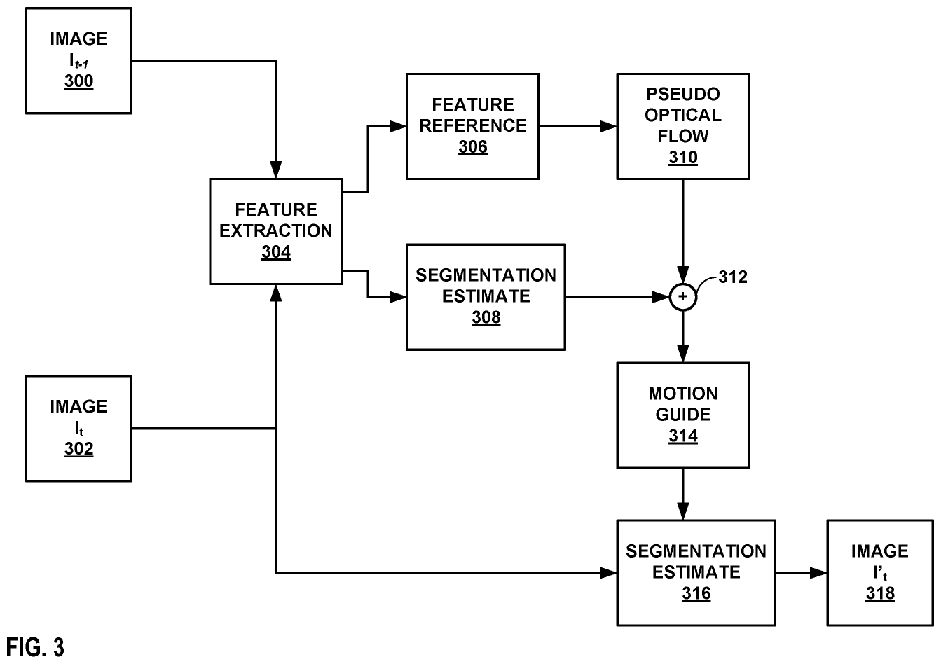

FIG. 3 is a conceptual diagram illustrating an example architecture for a device for video segmentation according to one or more aspects of this disclosure. The architecture of FIG. 3 may be implemented by device 100 of FIG. 1. For example, processor(s) 110 may extract features from a previous image Iₜ₋₁ 300 and a current image Iₜ via feature extraction unit 304. Previous image Iₜ₋₁ 300 and a current image Iₜ may be images captured by camera(s) 104. Feature extraction unit 304 may be implemented through the use of neural network or other machine learning model. The output of feature extraction unit 304 may be compared to a feature reference by feature reference unit 306 and the output of feature reference unit 306 may be input to a pseudo-optical flow unit 310 to produce a pseudo-optical flow.

In some examples, feature extraction unit 304 may be configured to perform semantic segmentation. Semantic segmentation is a technique for categorizing each pixel in an image (e.g., a frame of video data) into a class or object. For example, the output of a semantic segmentation may include a pixel-wise segmentation map of the image, where each pixel in the image is assigned to a specific class or object. For example, each pixel may be assigned a class label, which may be an identifier whose value is associated with a particular class to which the particular pixel belongs, such as 0 (tree), 1 (road), 2 (building), 3 (car), 4 (person), 5 (bicycle), etc. In some examples, such a segmentation map may not separate different objects within the class, such as two different bicycles. In other examples, such as with the use of an instance segmentation model, the output segmentation map may differentiate between different objects within the class. In some examples, a feature of a pixel may include the class to which the pixel belongs.

A particular object of a class may be localized, for example, by drawing a bounding box around the object. A segmentation mask may be used to group the pixels of a particular object in a localized image. Features of the image may be extracted using semantic segmentation to separate the image into a plurality of segments.

A convolutional network that is used to extract features from an image may be referred to as an encoder. In some examples, an encoder also downsamples the image, while a convolutional network that is used for upsampling may be referred to as a decoder. In some examples, feature extraction unit 304 or a segmentation unit may include an encoder and/or a decoder.

The output of feature extraction unit 304 may include segmentation estimate 308. Segmentation estimate 308 may be an estimate of segmentation (e.g., a segmentation prediction) for current image Iₜ.

Segmentation estimate 308 and the output of pseudo-optical flow unit 310 may be combined by adder 312 and input to motion guide unit 314 to determine a motion guide 314.

Current image Iₜ 302 may be input to segmentation estimate unit 316 (which may be the same as segmentation estimate unit 308 or different than segment estimate unit 308). Motion guide information from motion guide unit 314 may also be input to segmentation estimate unit 316. Segment estimate unit 316 may output a predicted current image I′ₜ 318.

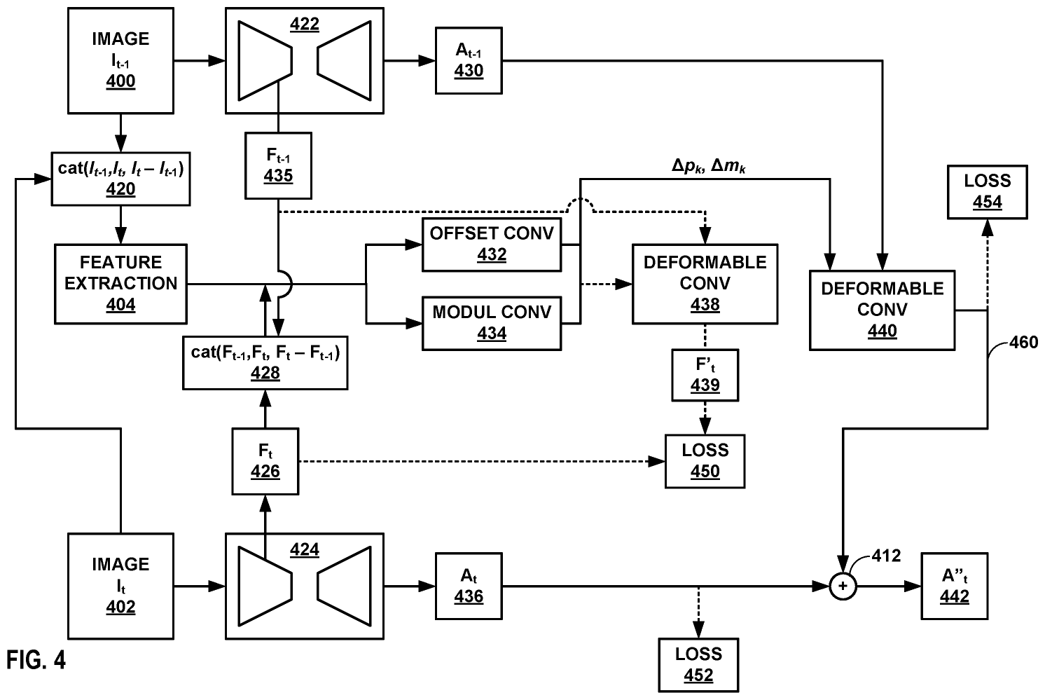

FIG. 4 is a conceptual diagram illustrating an example more detailed architecture for a device for video segmentation according to one or more aspects of this disclosure. The architecture of FIG. 4 may be implemented by device 100 of FIG. 1.

A previous image Iₜ₋₁ 400, which may be an example of previous image Iₜ₋₁ 300, and a current image Iₜ 402, which may be an example of current image Iₜ 302 may be captured by camera(s) 104. Concatenation unit 420 may concatenate previous image Iₜ₋₁ 400, current image Iₜ 402, and a difference therebetween. Feature extraction unit 404 may extract feature(s) from the output of concatenation unit 420. Feature extraction unit 404 may be an example of feature extraction unit 304 and may include a machine learning model, such as an encoder.

Previous image Iₜ₋₁ 400 may be input to a feature extraction unit 422, which may include a machine learning model having an encoder portion and decoder portion. The output of the encoder portion of feature extraction 422 may represent features Fₜ₋₁ 435 of the previous image Iₜ₋₁ 400. Similarly, current image Iₜ 402 may be input to feature extractor 424 (which may be the same as or different than feature extractor 422). Feature extractor 424 may include machine learning model having an encoder portion and decoder portion. The output of the encoder portion of feature extractor 424 may represent features Fₜ 426 of the current image Iₜ 402.

Concatenation unit 428 (which may be the same as or different than concatenation unit 420) may concatenate feature Fₜ426, feature Fₜ. 435, and a difference therebetween.

The output of feature extraction unit 404 and concatenation unit 428 may be input to offset convolution unit 432 and modulation convolution unit 434. Offset convolution unit 432 may be configured to determine how much respective pixels have moved between previous image Iₜ₋₁ 400 and current image Iₜ 402. Modulation convolution unit 434 may be configured to determine a relative importance (e.g., a weight) of one or more features each of the respective pixels. The output of offset convolution unit 432, Δpₖ, and the output of modulation convolution unit 434, Δmₖ, may be input to deformable convolution unit 440 which may perform a deformable convolution operation on Δpₖ and Δmₖ. While offset convolution unit 432 and modulation convolution unit 434 are shown separately from deformable convolution unit 440, in some examples, either one of, or both of, offset convolution unit 432 or modulation convolution unit 434 may be implemented as one or more layers of deformable convolution unit 440.

Feature extraction unit 422 may output segmentation data Aₜ₋₁ 430, which may be input to deformable convolution unit 440. Feature extraction unit 424 may output segmentation data Aₜ 436. The output 460 of deformable convolution unit 440 and segmentation data Aₜ 436 may be combined by adder 412, which may be an example of adder 312, which may output segmentation data A″ₜ 442. Segmentation data A″ₜ 442 may include segmentation data for current image Iₜ 402 that has improved properties with respect to flickering error than segmentation data Aₜ 436.

While training the machine learning models of this disclosure, processor(s) 110 may generate losses 450, 452, and/or 454. Losses 450, 452, and/or 454 may be used to affect predictions or estimates made by device 100 implementing the architecture of FIG. 4 to, for example, segmentation data A″ₜ 442. For example, losses 450, 452, and/or 454 may be used to train offset convolution unit 432, modulation convolution unit 434, deformable convolution unit 438, and/or deformable convolution unit 440. In some examples, training occurs off-device.

For example, the output of offset convolution unit 432 and modulation convolution unit 434 may be input to deformable convolution unit 438 (which may be the same as or different than deformable convolution unit 440), as well as features Fₜ₋₁ 435. While offset convolution unit 432 and modulation convolution unit 434 are shown separately from deformable convolution unit 438, in some example, either one of, or both of, offset convolution unit 432 or modulation convolution unit 434 may be implemented as one or more layers of deformable convolution unit 438.

Deformable convolution unit 438 may determine predicted features F′ₜ 439. Processor(s) 110 may generate loss 450 based on features Fₜ 426 and predicted features F′ₜ 439. Processor(s) 110 may generate loss 452 based on segmentation data Aₜ 436. Processor(s) 110 may generate loss 454 based on the output 460 of deformable convolution unit 440.

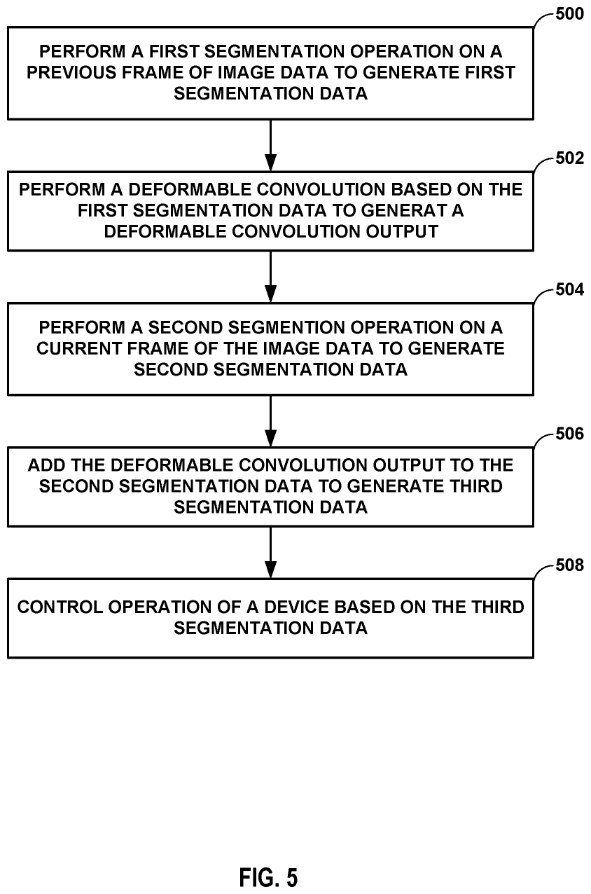

FIG. 5 is a flow diagram illustrating example temporal consistency techniques for image segmentation according to one or more aspects of this disclosure. The techniques of FIG. 5 are discussed with respect to FIGS. 1 and 4. However, these techniques may be practiced by any system or device capable of doing so.

Processor(s) 110 may perform a first segmentation operation on a previous frame of image data to generate first segmentation data (500). For example, processor(s) 110 may perform the first segmentation operation via segmentation unit 422 on previous image Iₜ₋₁ 400 to generate segmentation data Aₜ₋₁ 430. Segmentation unit 422 may include a machine learning model.

Processor(s) 110 may perform a deformable convolution operation based on the first segmentation data, to generate a deformable convolution output (502). For example, processor(s) 110 may perform the deformable convolution operation via deformable convolution unit 440 based on segmentation data Aₜ₋₁ 430, to generate the deformable convolution output.

Processor(s) 110 may perform a second segmentation operation on a current frame of the image data to generate second segmentation data (504). For example, processor(s) 110 may perform the second segmentation operation via segmentation unit 424 on current image Iₜ 402 to generate segmentation data Aₜ 436. Segmentation unit 424 may include a machine learning model.

Processor(s) 110 may combine the deformable convolution output with the second segmentation data to generate third segmentation data (506). For example, processor(s) 110 may use adder 412 to combine the deformable convolution output 460 with segmentation data Aₜ 436 to generate segmentation data A″ₜ 442.

Processor(s) 110 may control operation of a device based on the third segmentation data (508). For example, processor(s) 110 may control device 100 based on segmentation data A″ₜ 442. For example, segmentation data A″ₜ 442 may represent a semantic segmentation that is corrected to reduce or eliminate flickering error of segmented data. For example, processor(s) 110 may control an ego vehicle to stay on a road and off a sidewalk based on segmentation data A″ₜ 442.

In some examples, at least of the one first segmentation operation or the second segmentation operation is a semantic segmentation operation. In some examples, processor(s) 110 perform the first segmentation operation and the second segmentation operation using a machine learning model.

In some examples, the deformable convolution operation (e.g., of deformable convolution unit 440) is further based on an offset convolution operation and a modulation convolution operation. For example, offset convolution unit 432 and modulation convolution unit 434 may provide respective outputs which may be used to perform the deformable convolution operation.

In some examples, processor(s) 110 may extract features from the previous frame of image data (e.g., previous image Iₜ₋₁ 400) to generate first extracted features Fₜ₋₁. Processor(s) 110 may extract features from the current frame of image data (e.g., current image Iₜ 402) to generate second extracted features Fₜ 426. Processor(s) 110 may concatenate (e.g., using concatenation unit 420) the first extracted features Fₜ₋₁ 435, the second extracted features Fₜ 426, and a difference between the second extracted features and the first extracted features (e.g., Fₜ 426−Fₜ₋₁ 435), to generate concatenated extracted features. Processor(s) 110 may concatenate the previous frame of the image data (e.g., previous image Iₜ₋₁ 400), the current frame of the image data (e.g., current image Iₜ 402), and a difference between the current frame of the image data and the previous frame of the image data (e.g., current image Iₜ 402—previous image Iₜ₋₁ 400) to generate concatenated image data. Processor(s) 110 may extract features (e.g., via feature extraction unit 404) from the concatenated image data to generate third extracted features. In some examples, processor(s) 110 may perform the offset convolution operation on the third extracted features and the concatenated extracted features. In some examples, processor(s) 110 may perform the modulation convolution operation on the third extracted features and the concatenated extracted features.

In some examples, first extracted features Fₜ. 435 include an output of an encoder of a first machine learning model, second extracted features Fₜ 426 comprise an output of an encoder of a second machine learning model, and the third extracted features comprise an output of an encoder of a third machine learning model.

In some examples, the deformable convolution operation is a first deformable convolution operation and deformable convolution output 460 is a first deformable convolution output. In such examples, processor(s) 110 may determine a first loss 450, first loss 450 being based on second extracted features Fₜ 426 and a second deformable convolution output (e.g., an output of deformable convolution unit 438 (which may be the same as or different than deformable convolution unit 440), predicted features F′ₜ). In some examples, the second deformable convolution output is based on the first extracted features Fₜ₋₁ 435, the offset convolution output, and the modulation convolution output. In some examples, processor(s) 110 train at least one of a machine learning model of the offset convolution operation, a machine learning model of the modulation convolution operation, or a machine learning model of the first deformable convolution operation based on first loss 450.

In some examples, processor(s) 110 may determine a second loss 452, second loss 452 being based on second segmentation data Aₜ 436, and train at least one of a machine learning model of the offset convolution operation, a machine learning model of the modulation convolution operation, or a machine learning model of the first deformable convolution operation based on second loss 452. In some examples, processor(s) 110 may determine a third loss 454, third loss 454 being based on the deformable convolution output (e.g., output of deformable convolution unit 440) and train at least one of a machine learning model of the offset convolution operation, a machine learning model of the modulation convolution operation, or a machine learning model of the first deformable convolution operation based on third loss 454.

In some examples, device 100 includes a vehicle or a robot and wherein as part of controlling operation of the vehicle or the robot, processor(s) 110 may navigate the vehicle or the robot in environment 195.

Examples in the various aspects of this disclosure may be used individually or in any combination.

This disclosure includes the following clauses.
Clause 1. A system comprising: one or more memories configured to store image data captured by at least one camera; and one or more processors communicatively coupled to the one or more memories, the one or more processors being configured to: perform a first segmentation operation on a previous frame of the image data to generate first segmentation data; perform a deformable convolution operation based on the first segmentation data, to generate a deformable convolution output; perform a second segmentation operation on a current frame of the image data to generate second segmentation data; combine the deformable convolution output with the second segmentation data to generate third segmentation data; and control operation of a device based on the third segmentation data.
Clause 2. The system of clause 1, wherein at least one of the first segmentation operation or the second segmentation operation is a semantic segmentation operation.
Clause 3. The system of clause 1 or clause 2, wherein the one or more processors are configured to perform the first segmentation operation and the second segmentation operation using a machine learning model.
Clause 4. The system of any of clauses 1-3, wherein the deformable convolution operation is further based on an offset convolution operation and a modulation convolution operation.
Clause 5. The system of clause 4, wherein the one or more processors are further configured to: extract features from the previous frame of image data to generate first extracted features; extract features from the current frame of image data to generate second extracted features; concatenate the first extracted features, the second extracted features, and a difference between the second extracted features and the first extracted features, to generate concatenated extracted features; concatenate the previous frame of the image data, the current frame of the image data, and a difference between the current frame of the image data and the previous frame of the image data to generate concatenated image data; and extract features from the concatenated image data to generate third extracted features, wherein the one or more processors are configured to perform the offset convolution operation on the third extracted features and the concatenated extracted features, and wherein the one or more processors are configured to perform the modulation convolution operation on the third extracted features and the concatenated extracted features.
Clause 6. The system of clause 5, wherein the first extracted features comprise an output of an encoder of a first machine learning model, the second extracted features comprise an output of an encoder of a second machine learning model, and the third extracted features comprise an output of an encoder of a third machine learning model.
Clause 7. The system of clause 5 or clause 6, wherein the deformable convolution operation is a first deformable convolution operation, the deformable convolution output is a first deformable convolution output, and wherein the one or more processors are further configured to: determine a first loss, the first loss being based on the second extracted features and a second deformable convolution output, wherein the second deformable convolution output is based on the first extracted features, an output of the offset convolution operation, and an output of the modulation convolution operation; and train at least one of a machine learning model of the offset convolution operation, a machine learning model of the modulation convolution operation, or a machine learning model of the first deformable convolution operation based on the first loss.
Clause 8. The system of clause 7, wherein the one or more processors are further configured to: determine a second loss, the second loss being based on the second segmentation data; and train at least one of the machine learning model of the offset convolution operation, the machine learning model of the modulation convolution operation, or the machine learning model of the first deformable convolution operation based on the second loss.
Clause 9. The system of clause 7 or clause 8, wherein the one or more processors are further configured to: determine a third loss, the third loss being based on the deformable convolution output; and train at least one of the machine learning model of the offset convolution operation, the machine learning model of the modulation convolution operation, or the machine learning model of the first deformable convolution operation based on the third loss.
Clause 10. The system of any of clauses 1-9, wherein the device comprises a vehicle or a robot, and wherein as part of controlling operation of the vehicle or the robot, the one or more processors are configured to navigate the vehicle or the robot in an environment.
Clause 11. A method comprising: performing a first segmentation operation on a previous frame of image data to generate first segmentation data; performing a deformable convolution operation based on the first segmentation data, to generate a deformable convolution output; performing a second segmentation operation on a current frame of the image data to generate second segmentation data; combining the deformable convolution output with the second segmentation data to generate third segmentation data; and controlling operation of a device based on the third segmentation data.
Clause 12. The method of clause 11, wherein at least one of the first segmentation operation or the second segmentation operation is a semantic segmentation operation.
Clause 13. The method of clause 11 or clause 12, wherein performing the first segmentation operation and performing the second segmentation operation comprises using a machine learning model.
Clause 14. The method of any of clauses 11-13, wherein performing the deformable convolution operation is further based on an offset convolution operation and a modulation convolution operation.
Clause 15. The method of clause 14, further comprising: extracting features from the previous frame of the image data to generate first extracted features; extracting features from the current frame of the image data to generate second extracted features; concatenating the first extracted features, the second extracted features, and a difference between the second extracted features and the first extracted features, to generate concatenated extracted features; concatenating the previous frame of the image data, the current frame of the image data, and a difference between the current frame of the image data and the previous frame of the image data to generate concatenated image data; extracting features from the concatenated image data to generate third extracted features; performing the offset convolution operation on the third extracted features and the concatenated extracted features; and performing the modulation convolution operation on the third extracted features and the concatenated extracted features.
Clause 16. The method of clause 15, wherein the first extracted features comprise an output of an encoder of a first machine learning model, the second extracted features comprise an output of an encoder of a second machine learning model, and the third extracted features comprise an output of an encoder of a third machine learning model.
Clause 17. The method of clause 15 or clause 16, wherein the deformable convolution operation is a first deformable convolution operation, the deformable convolution output is a first deformable convolution output, further comprising: determining a first loss, the first loss being based on the second extracted features and a second deformable convolution output, wherein the second deformable convolution output is based on the first extracted features, the offset convolution output, and the modulation convolution output; and training at least one of a machine learning model of the offset convolution operation, a machine learning model of the modulation convolution operation, or a machine learning model of the first deformable convolution operation based on the first loss.
Clause 18. The method of clause 17, further comprising: determining a second loss, the second loss being based on the second segmentation data; and training at least one of the machine learning model of the offset convolution operation, the machine learning model of the modulation convolution operation, or the machine learning model of the first deformable convolution operation based on the second loss.
Clause 19. The method of clause 17 or clause 18, further comprising: determining a third loss, the third loss being based on the deformable convolution output; and training at least one of the machine learning model of the offset convolution operation, the machine learning model of the modulation convolution operation, or the machine learning model of the first deformable convolution operation based on the third loss.
Clause 20. The method of any of clauses 11-19, wherein the device comprises a vehicle or a robot and wherein as part of controlling operation of the vehicle or the robot, the one or more processors are configured to navigate the vehicle or the robot in an environment.
Clause 21. Non-transitory computer-readable storage media storing instructions, which, when executed, cause one or more processors to: perform a first segmentation operation on a previous frame of image data to generate first segmentation data; perform a deformable convolution operation based on the first segmentation data, to generate a deformable convolution output; perform a second segmentation operation on a current frame of the image data to generate second segmentation data; combine the deformable convolution output with the second segmentation data to generate third segmentation data; and control operation of a device based on the third segmentation data.
Clause 22. The storage media of clause 21, wherein at least one of the first segmentation operation or the second segmentation operation is a semantic segmentation operation.
Clause 23. The storage media of clause 21 or clause 22, wherein the instructions further cause the one or more processors to perform the first segmentation operation and the second segmentation operation using a machine learning model.
Clause 24. The storage media of any of clauses 21-23, wherein the deformable convolution operation is further based on an offset convolution operation and a modulation convolution operation.
Clause 25. The storage media of clause 24, wherein instructions further cause the one or more processors to: extract features from the previous frame of the image data to generate first extracted features; extract features from the current frame of the image data to generate second extracted features; concatenate the first extracted features, the second extracted features, and a difference between the second extracted features and the first extracted features, to generate concatenated extracted features; concatenate the previous frame of the image data, the current frame of the image data, and a difference between the current frame of the image data and the previous frame of the image data to generate concatenated image data; and extract features from the concatenated image data to generate third extracted features, wherein the instructions cause the one or more processors to perform the offset convolution operation on the third extracted features and the concatenated extracted features, and wherein the instructions cause the one or more processors to perform the modulation convolution operation on the third extracted features and the concatenated extracted features.
Clause 26. The storage media of clause 25, wherein the first extracted features comprise an output of an encoder of a first machine learning model, the second extracted features comprise an output of an encoder of a second machine learning model, and the third extracted features comprise an output of an encoder of a third machine learning model.
Clause 27. The storage media of clause 25 or clause 26, wherein the deformable convolution operation is a first deformable convolution operation, the deformable convolution output is a first deformable convolution output, and wherein instructions further cause the one or more processors to: determine a first loss, the first loss being based on the second extracted features and a second deformable convolution output, wherein the second deformable convolution output is based on the first extracted features, the offset convolution output, and the modulation convolution output; and train at least one of a machine learning model of the offset convolution operation, a machine learning model of the modulation convolution operation, or a machine learning model of the first deformable convolution operation based on the first loss.
Clause 28. The storage media of clause 27, wherein the instructions further cause the one or more processors to: determine a second loss, the second loss being based on the second segmentation data; and train at least one of the machine learning model of the offset convolution operation, the machine learning model of the modulation convolution operation, or the machine learning model of the first deformable convolution operation based on the second loss.
Clause 29. The storage media of clause 27 or clause 28, wherein the one or more processors are further configured to: determine a third loss, the third loss being based on the deformable convolution output; and train at least one of the machine learning model of the offset convolution operation, the machine learning model of the modulation convolution operation, or the machine learning model of the first deformable convolution operation based on the third loss.
Clause 30. A system comprising: means for performing a first segmentation operation on a previous frame of image data to generate first segmentation data; means for performing a deformable convolution operation based on the first segmentation data, to generate a deformable convolution output; means for performing a second segmentation operation on a current frame of the image data to generate second segmentation data; means for combining the deformable convolution output with the second segmentation data to generate third segmentation data; and means for controlling operation of a device based on the third segmentation data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A system comprising:
one or more memories configured to store image data captured by at least one camera; and
one or more processors communicatively coupled to the one or more memories, the one or more processors being configured to:
perform a first segmentation operation on a previous frame of the image data to generate first segmentation data;
perform a deformable convolution operation based on the first segmentation data, to generate a deformable convolution output;
perform a second segmentation operation on a current frame of the image data to generate second segmentation data;
combine the deformable convolution output with the second segmentation data to generate third segmentation data; and
control operation of a device based on the third segmentation data.

2. The system of claim 1, wherein at least one of the first segmentation operation or the second segmentation operation is a semantic segmentation operation.

3. The system of claim 1, wherein the one or more processors are configured to perform the first segmentation operation and the second segmentation operation using a machine learning model.

4. The system of claim 1, wherein the deformable convolution operation is further based on an offset convolution operation and a modulation convolution operation.

5. The system of claim 4, wherein the one or more processors are further configured to:
extract features from the previous frame of image data to generate first extracted features;
extract features from the current frame of image data to generate second extracted features;
concatenate the first extracted features, the second extracted features, and a difference between the second extracted features and the first extracted features, to generate concatenated extracted features;
concatenate the previous frame of the image data, the current frame of the image data, and a difference between the current frame of the image data and the previous frame of the image data to generate concatenated image data; and
extract features from the concatenated image data to generate third extracted features,
wherein the one or more processors are configured to perform the offset convolution operation on the third extracted features and the concatenated extracted features, and
wherein the one or more processors are configured to perform the modulation convolution operation on the third extracted features and the concatenated extracted features.

6. The system of claim 5, wherein the first extracted features comprise an output of an encoder of a first machine learning model, the second extracted features comprise an output of an encoder of a second machine learning model, and the third extracted features comprise an output of an encoder of a third machine learning model.

7. The system of claim 5, wherein the deformable convolution operation is a first deformable convolution operation, the deformable convolution output is a first deformable convolution output, and wherein the one or more processors are further configured to:
determine a first loss, the first loss being based on the second extracted features and a second deformable convolution output, wherein the second deformable convolution output is based on the first extracted features, an output of the offset convolution operation, and an output of the modulation convolution operation; and
train at least one of a machine learning model of the offset convolution operation, a machine learning model of the modulation convolution operation, or a machine learning model of the first deformable convolution operation based on the first loss.

8. The system of claim 7, wherein the one or more processors are further configured to:
determine a second loss, the second loss being based on the second segmentation data; and
train at least one of the machine learning model of the offset convolution operation, the machine learning model of the modulation convolution operation, or the machine learning model of the first deformable convolution operation based on the second loss.

9. The system of claim 8, wherein the one or more processors are further configured to:
determine a third loss, the third loss being based on the deformable convolution output; and
train at least one of the machine learning model of the offset convolution operation, the machine learning model of the modulation convolution operation, or the machine learning model of the first deformable convolution operation based on the third loss.

10. The system of claim 1, wherein the device comprises a vehicle or a robot, and wherein as part of controlling operation of the vehicle or the robot, the one or more processors are configured to navigate the vehicle or the robot in an environment.

11. A method comprising:
performing a first segmentation operation on a previous frame of image data to generate first segmentation data;
performing a deformable convolution operation based on the first segmentation data, to generate a deformable convolution output;
performing a second segmentation operation on a current frame of the image data to generate second segmentation data;
combining the deformable convolution output with the second segmentation data to generate third segmentation data; and
controlling operation of a device based on the third segmentation data.

12. The method of claim 11, wherein at least one of the first segmentation operation or the second segmentation operation is a semantic segmentation operation.

13. The method of claim 11, wherein performing the first segmentation operation and performing the second segmentation operation comprises using a machine learning model.

14. The method of claim 11, wherein performing the deformable convolution operation is further based on an offset convolution operation and a modulation convolution operation.

15. The method of claim 14, further comprising:
extracting features from the previous frame of the image data to generate first extracted features;
extracting features from the current frame of the image data to generate second extracted features;
concatenating the first extracted features, the second extracted features, and a difference between the second extracted features and the first extracted features, to generate concatenated extracted features;
concatenating the previous frame of the image data, the current frame of the image data, and a difference between the current frame of the image data and the previous frame of the image data to generate concatenated image data;
extracting features from the concatenated image data to generate third extracted features;
performing the offset convolution operation on the third extracted features and the concatenated extracted features; and
performing the modulation convolution operation on the third extracted features and the concatenated extracted features.

16. The method of claim 15, wherein the first extracted features comprise an output of an encoder of a first machine learning model, the second extracted features comprise an output of an encoder of a second machine learning model, and the third extracted features comprise an output of an encoder of a third machine learning model.

17. The method of claim 15, wherein the deformable convolution operation is a first deformable convolution operation, the deformable convolution output is a first deformable convolution output, further comprising:
determining a first loss, the first loss being based on the second extracted features and a second deformable convolution output, wherein the second deformable convolution output is based on the first extracted features, the offset convolution output, and the modulation convolution output; and
training at least one of a machine learning model of the offset convolution operation, a machine learning model of the modulation convolution operation, or a machine learning model of the first deformable convolution operation based on the first loss.

18. The method of claim 17, further comprising:
determining a second loss, the second loss being based on the second segmentation data; and
training at least one of the machine learning model of the offset convolution operation, the machine learning model of the modulation convolution operation, or the machine learning model of the first deformable convolution operation based on the second loss.

19. The method of claim 18, further comprising:
determining a third loss, the third loss being based on the deformable convolution output; and
training at least one of the machine learning model of the offset convolution operation, the machine learning model of the modulation convolution operation, or the machine learning model of the first deformable convolution operation based on the third loss.

20. The method of claim 11, wherein the device comprises a vehicle or a robot and wherein as part of controlling operation of the vehicle or the robot, the one or more processors are configured to navigate the vehicle or the robot in an environment.

21. Non-transitory computer-readable storage media storing instructions, which, when executed, cause one or more processors to:
perform a first segmentation operation on a previous frame of image data to generate first segmentation data;
perform a deformable convolution operation based on the first segmentation data, to generate a deformable convolution output;
perform a second segmentation operation on a current frame of the image data to generate second segmentation data;
combine the deformable convolution output with the second segmentation data to generate third segmentation data; and
control operation of a device based on the third segmentation data.

22. The storage media of claim 21, wherein at least one of the first segmentation operation or the second segmentation operation is a semantic segmentation operation.

23. The storage media of claim 21, wherein the instructions further cause the one or more processors to perform the first segmentation operation and the second segmentation operation using a machine learning model.

24. The storage media of claim 21, wherein the deformable convolution operation is further based on an offset convolution operation and a modulation convolution operation.

25. The storage media of claim 24, wherein instructions further cause the one or more processors to:
extract features from the previous frame of the image data to generate first extracted features;
extract features from the current frame of the image data to generate second extracted features;
concatenate the first extracted features, the second extracted features, and a difference between the second extracted features and the first extracted features, to generate concatenated extracted features;
concatenate the previous frame of the image data, the current frame of the image data, and a difference between the current frame of the image data and the previous frame of the image data to generate concatenated image data; and
extract features from the concatenated image data to generate third extracted features,
wherein the instructions cause the one or more processors to perform the offset convolution operation on the third extracted features and the concatenated extracted features, and
wherein the instructions cause the one or more processors to perform the modulation convolution operation on the third extracted features and the concatenated extracted features.

26. The storage media of claim 25, wherein the first extracted features comprise an output of an encoder of a first machine learning model, the second extracted features comprise an output of an encoder of a second machine learning model, and the third extracted features comprise an output of an encoder of a third machine learning model.

27. The storage media of claim 25, wherein the deformable convolution operation is a first deformable convolution operation, the deformable convolution output is a first deformable convolution output, and wherein instructions further cause the one or more processors to:
determine a first loss, the first loss being based on the second extracted features and a second deformable convolution output, wherein the second deformable convolution output is based on the first extracted features, the offset convolution output, and the modulation convolution output; and
train at least one of a machine learning model of the offset convolution operation, a machine learning model of the modulation convolution operation, or a machine learning model of the first deformable convolution operation based on the first loss.

28. The storage media of claim 27, wherein the instructions further cause the one or more processors to:
determine a second loss, the second loss being based on the second segmentation data; and
train at least one of the machine learning model of the offset convolution operation, the machine learning model of the modulation convolution operation, or the machine learning model of the first deformable convolution operation based on the second loss.

29. The storage media of claim 28, wherein the one or more processors are further configured to:
determine a third loss, the third loss being based on the deformable convolution output; and
train at least one of the machine learning model of the offset convolution operation, the machine learning model of the modulation convolution operation, or the machine learning model of the first deformable convolution operation based on the third loss.

30. A system comprising:
means for performing a first segmentation operation on a previous frame of image data to generate first segmentation data;
means for performing a deformable convolution operation based on the first segmentation data, to generate a deformable convolution output;
means for performing a second segmentation operation on a current frame of the image data to generate second segmentation data;
means for combining the deformable convolution output with the second segmentation data to generate third segmentation data; and
means for controlling operation of a device based on the third segmentation data.
